(19) United States
(12) Patent Application Publication
(10) Pub. No.: US 2022/0057651 A1
(43) Pub. Date: Feb. 24, 2022

(54) USING SIMULATED LONGITUDINAL CHROMATIC ABERRATION TO CONTROL MYOPIC PROGRESSION

(71) Applicant: X Development LLC, Mountain View, CA (US)

(72) Inventors: Joel Segre, Oakland, CA (US); Alexandre Tumlinson, San Leandro, CA (US)

(21) Appl. No.: 17/185,538

(22) Filed: Feb. 25, 2021

Related U.S. Application Data
(60) Provisional application No. 63/066,959, filed on Aug. 18, 2020.

(51) Int. Cl. G02C 7/04; G02C 7/10

(52) U.S. Cl. CPC G02C 7/042; G02C 2202/24; G02C 7/102

(57) ABSTRACT

A technique for driving emmetropization of an eye includes receiving image data corresponding to a color image; blurring a first color channel of the image data greater than a second color channel of the image data in at least a portion of the color image to provide a simulated longitudinal chromatic aberration (LCA) in the portion of the color image; and displaying the color image with the simulated LCA to provide an emmetropization therapy to the eye.

### CROSS-REFERENCE TO RELATED APPLICATIONS

This application claims the benefit of U.S. Provisional Patent Application No. 63/066,959, filed Aug. 18, 2020, which is incorporated herein by reference in its entirety.

### TECHNICAL FIELD

This disclosure relates generally to ophthalmic devices and techniques, and in particular but not exclusively, relates to ophthalmic devices and techniques for controlling myopia.

### BACKGROUND INFORMATION

Myopia, or nearsightedness, is a refractive effect that causes people to be able to focus on objects near to them, while objects far away are blurry. Typical treatment for myopia is to wear a negatively powered spectacle or contact lens. Myopia is caused by an eyeball length that is longer than normal. This extended shape causes multiple problems in addition to defocus. The process which determines the length of a human's eye has both genetic and environmental factors. Experiments in multiple species, including humans, have shown that a normal eye attempts a process known as emmetropization to control its growth in a closed-loop fashion such that it grows to the appropriate length where visual stimulus from the environment is focused on the retina.

Myopia currently affects approximately 30% of the human population and this number is anticipated to significantly expand through 2050. Myopia is particularly acute in East Asian countries where genetic factors and cultural norms may work together to drive particularly high myopia rates in children. In fact, overwhelming majorities of college-aged, urban populations in East Asia suffer from near-sightedness. The increasing prevalence of myopia is believed to be associated with increased near work while the eye is growing in adolescence. A major contributor to near work is not just books, but screen time associated with personal computing devices.

FIG. 1 (PRIOR ART) illustrates an emmetropic (e.g., normal) eye 100, a hyperopic eye 101, and a myopic eye 102. In the emmetropic eye 100, light 105 is brought to a focus on retina 110. In other words, the focal length 115A of the optical system including cornea 120 and crystalline lens 125 of emmetropic eye 100 brings light 105 to a focus substantially co-incident with retina 110. In hyperopic eye 101, light 105 is brought to a focus behind retina 110 at focal length 115B as a result of the axial length of the eye shortening and bringing the posterior surface (i.e., retina 110) closer to cornea 120. In myopic eye 102, light 105 coming from optical infinity is brought to a focus in front of retina 110 at focal length 115C as a result of an increase in the axial length of the eye (i.e. a greater distance between cornea 120 and retina 110).

The optical geometry of an emmetropic eye 100 is remarkably maintained to within microns of optimal alignment despite the eye representing a complex multi-component optical system that increases by roughly 50% in length from birth to adulthood. This alignment is achieved using feedback growth signals that encourage or discourage growth based upon small amounts of hyperopic or myopic defocus experienced during growth years. As mentioned above, these feedback growth signals/cues are believed to be responsible for controlling the emmetropization process. However, exposure to prolonged, daily periods of near-field vision tasks (e.g., regular screen time on a portable computing device) and other aspects of modern life may alter this feedback loop, thereby preventing the appropriate feedback growth signals. If myopia is allowed to progress too far, it is correlated with more serious conditions later in life such as retinal detachment, glaucoma, macular degeneration, cataracts, as well as other deleterious conditions.

Conventional approaches to treating or controlling the onset of myopia fail to show consistently high degrees of effectivity and are often accompanied by undesirable side effects. Such undesirable side effects include blurred vision in a portion of the visual field (e.g., as caused by bifocal/multifocal lenses), an inability to achieve near-field focus (e.g., as caused by atropine eye drops), or temporary vision impairment along with stable, though not permanent, correction associated with mechanical tissue reshaping (e.g., orthokeratology).

An effective approach to treating or controlling the onset of myopia (or hyperopia) in a safe, effective, and cost-efficient manner is desirable not only to treat a current ophthalmic condition, but also could save large numbers of the population from suffering significant visual impairment later in life.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 (PRIOR ART) illustrates the conditions of hyperopia and myopia relative to a normal emmetropic eye.

FIG. 2A is a cross-sectional illustration of an eye illustrating normal longitudinal chromatic aberration (LCA).

FIG. 2B is a cross-sectional illustration of an eye illustrating a myopic defocus across substantially a full field of view (FOV) to provide emmetropization therapy to the eye, in accordance with an embodiment of the disclosure.

FIG. 2C is a cross-sectional illustration of an eye illustrating a peripheral myopic defocus limited to a peripheral FOV to provide emmetropization therapy to the eye, in accordance with an embodiment of the disclosure.

FIG. 3A illustrates how peripheral visual stimulation having simulated LCA can provide emmetropization therapy, in accordance with an embodiment of the disclosure.

FIG. 3B illustrates delineations between a central FOV and a peripheral FOV, in accordance with embodiments of the disclosure.

FIG. 4 is a block diagram illustrating a system for providing emmetropization therapy using simulated LCA, in accordance with an embodiment of the disclosure.

FIG. 5 is a control architecture for introducing chromatic blurring into a selective portion of a color image to simulate LCA, in accordance with an embodiment of the disclosure.

FIG. 6 illustrates a demonstrative implementation of a personal computing device for providing emmetropization therapy, in accordance with an embodiment of the disclosure.

FIG. 7 is a flow chart illustrating a process of providing emmetropization therapy using simulated LCA, in accordance with an embodiment of the disclosure.

FIGS. 8A & 8B illustrate a demonstrative eye mountable device having a field curvature to provide emmetropization therapy using LCA, in accordance with an embodiment of the disclosure.

FIGS. 9A & 9B illustrate demonstrative ophthalmic eyewear having a field curvature to provide emmetropization therapy using LCA, in accordance with an embodiment of the disclosure.

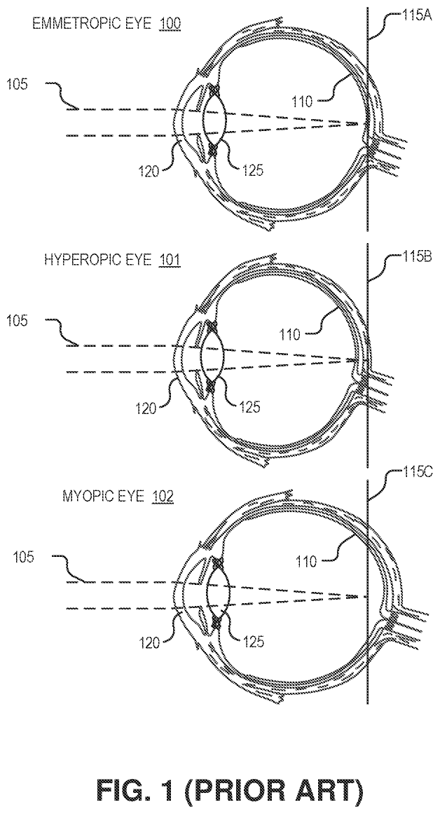

### DETAILED DESCRIPTION

Embodiments of a system, apparatus, and method for using simulated longitudinal chromatic aberration (LCA) to drive or encourage emmetropization are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Chromatic aberration is the failure of a lens (such as the human crystalline lens) to focus all wavelengths of light to a single point. There are two types of chromatic aberration: longitudinal (also referred to as axial) and transverse (also referred to as lateral). Longitudinal chromatic aberration (LCA) occurs when different wavelengths or colors of multi-color light are brought to focus at different offset distances from the lens. The crystalline lens and cornea of the human eye induce LCA. However, humans use LCA to beneficial ends. In fact, LCA is a significant driver of accommodation, helping our eyes bring objects into focus. It is also known that the chromatic information provided by LCA is involved in the process of emmetropization. For example, experiments show that animals deprived of chromatic bandwidth, grown in either short or long wavelengths exclusively, do not achieve emmetropization.

Accordingly, embodiments described herein use a simulated LCA to trigger desirable feedback growth cues to encourage or drive emmetropization of the eye. The simulated LCA is achieved by a form of chromatic blurring (i.e., wavelength dependent blurring) that selectively blurs one or more color channels or wavelengths differently than others. LCA as defined herein includes wavelength dependent blurring that may be applied across the visual spectrum, applied to a single color channel (e.g., just blue), or applied discontinuously across multiple wavelength bands (e.g., blurring blue and red color channels but not a green color channel). In some embodiments that treat myopia, shorter wavelength colors (e.g., blues) are more blurred relative to longer wavelength colors (e.g., reds). In some instances, there may be benefits to chromatic blurring red and blue, while leaving green substantially unblurred (or at least less blurred). The amount or degree of blurring between the red and blue channels may be equivalent, blue may be blurred to a greater extent than red, or in select scenarios red may be blurred to a greater extent than blue. In various therapeutic embodiments, the amount of chromatic blurring induced may range between 0 and 5 diopters of equivalent optical defocus, though approximately 3 diopters is anticipated to be suitable in certain therapeutic embodiments. The chromatic blurring may be achieved using spatial blurring (e.g., spreading chromatic pixel data), applying spatial frequency filtering, or potentially using phase shifting techniques. In various embodiments, the chromatic blurring is implemented computationally to produce the simulated LCA. The blurring of shorter wavelength color channels relative to the longer wavelength color channels in a color image simulates the effect of an optical myopic defocus, which is known to help slow or prevent the onset of myopia, and potentially reverse myopia. The simulated LCA described herein achieves the desirable effects of myopic defocus without having to defocus the image light use lensing power (e.g., refractive, diffractive, or specular lensing) as is required by conventional myopic treatment. In various embodiments, the simulated LCA may be generated entirely in software facilitating the use of virtually any electronic display (e.g., televisions, portable computing devices, etc.) to provide emmetropization therapy. In other words, the techniques described herein provide a safe and inexpensive way of transforming the very devices (e.g., personal computing devices such as smart phones, tables, and laptops) that are major contributing factors to the increasing prevalence of myopia into devices capable of beneficially providing emmetropization therapy, or at least, offsetting the negative effects of their use.

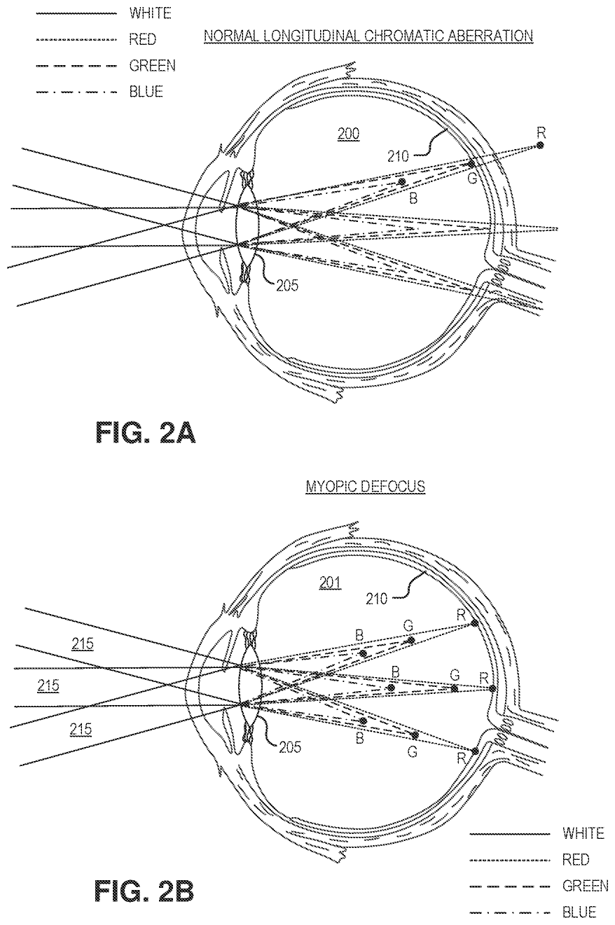

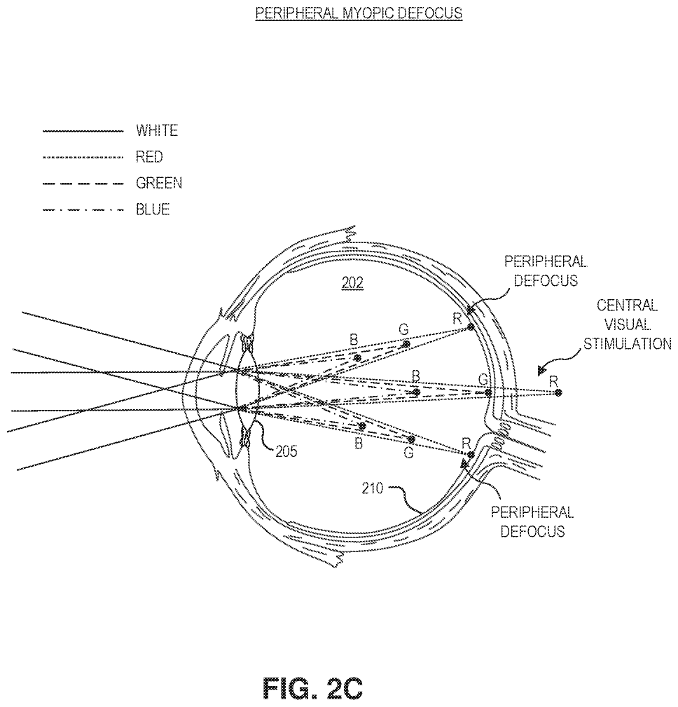

FIG. 2A is a cross-sectional illustration of a normal (emmetropic) eye 200 where lens 205 creates normal LCA. As illustrated, emmetropic eye 200 operates to bring green light to a crisp focus on retina 210, while LCA causes red light to be focused behind retina 210 and blue light to be focused in front of retina 210. Although red and blue wavelengths are not precisely focused on retina 210, the human mind compensates, and humans do not typically perceive this chromatic blur in the red and green bands. However, as mentioned above, the mind uses imperceptible feedback cues from LCA to drive both accommodation and eye growth for emmetropization. Extensive use of near-field vision (such as when reading or using portable computing devices) interferes with the emmetropization process.

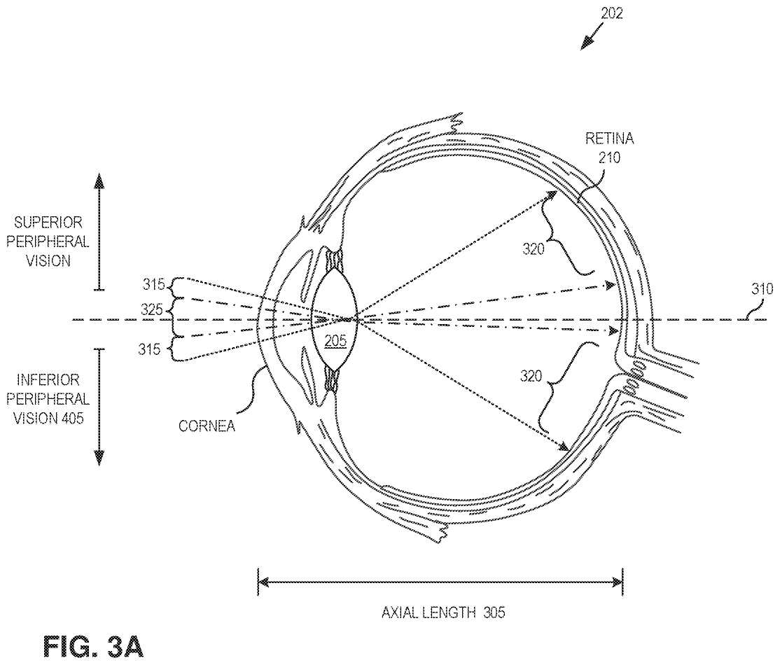

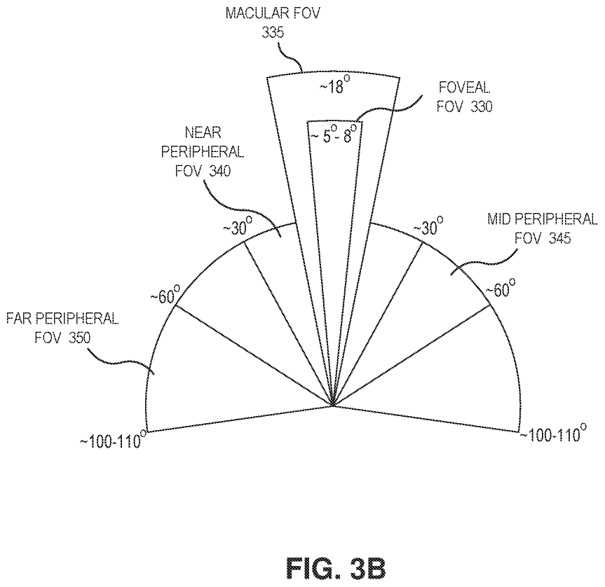

An eye that has unduly elongated along the axis running from the cornea to retina 210 through lens 205 becomes myopic (e.g., see elongation of axial length 305 along axis 310 in FIG. 3A). Myopic progression can be treated by intentionally myopically defocusing light incident upon the eye. The myopic defocus accentuates the feedback growth cues telling the eye to stop growing along the elongated dimension. FIG. 2B is a cross-sectional illustration of an eye 201 where incident light 215 is myopically defocused (using optical power) such that the focal distances of the red, green, and blue wavelengths are all shortened. In the illustrated embodiment, the myopic defocus brings red light (R) to a focus on retina 210 while both blue (B) and green (G) light are brought to a focus in front of retina 210. Accordingly, a myopic defocus is optically achieved when red light is brought to a sharp focus on retina 210 while blue and green light are defocused. Embodiments described herein simulate this myopic defocus by blurring (spatially or otherwise) blue or blue and green color channels in image data while leaving the red color channel unblurred. This has the effect of displaying a given color image pixel with a sharp red center surrounded by a blue or blue and green fringe. If greater levels of defocus are desired, myopic defocus of red is also an option.

FIG. 2B illustrates an example where the central and peripheral visions or field of views (FOVs) are both myopically defocused to provide the emmetropization therapy. Such full FOV myopic defocus may be achieved with refractive or diffractive lenses. However, the downside to this type of emmetropization therapy is the eye's full FOV is blurred. As such, the patient/user may not be willing to tolerate sufficiently long therapy durations.

Alternatively, just the eye's peripheral vision may be myopically defocused while leaving the eye's central vision unmaligned. It is believed that the beneficial feedback growth cues are still adequately stimulated with just peripheral visual stimulation. Since the majority of human acuity resided in the central vision, peripheral visual stimulation that only defocuses the peripheral vision may be more comfortable and less intrusive for the end user and thus tolerated for longer durations. FIG. 2C is a cross-sectional illustration of an eye 202 illustrating a peripheral myopic defocus limited to a peripheral FOV to provide emmetropization therapy to eye 202. As illustrated, the peripheral visual stimulation is myopically defocused while the central visual stimulation is left unaltered.

FIGS. 3A and 3B illustrate the peripheral visual stimulation scenario of FIG. 2C in greater detail. Peripheral visual stimulation 315, which is incident upon peripheral region 320 of retina 210 may be myopically defocused while the user's central vision 325 is left unmaligned. Placing myopically defocused light, or alternatively chromatically dependent blurred light as described below, in the peripheral vision is less intrusive than affecting the user's higher acuity central vision 325 thereby enabling the user to perform other daily tasks with their central vision 325 while receiving a myopia therapy directed at their peripheral vision. As such, the user is more likely to accept a myopia treatment regimen on a daily basis over longer periods of time. In various embodiments, eye tracking is used to track a user's gazing direction and adjust the emission position or emission angle of peripheral visual stimulation 315 to maintain defocused or color blurred light incident upon peripheral region 320 and outside the user's central vision 325.

FIG. 3B illustrates approximate delineations between a user's central and peripheral visions or FOVs. The user's central vision includes at least their foveal FOV 330 (light cone of approximately 5 to 8 degrees spanning a central optical axis) and may also be considered to include their macular FOV 335 (light cone of approximately 18 degrees spanning their central optical axis). In some embodiments, the user's central vision may even be considered to extend all the way into to their near peripheral FOV 340 (light cone of approximately 60 degrees spanning their central optical axis). The user's peripheral vision includes the far peripheral FOV 350 and mid peripheral FOV 345. In some embodiments, the user's peripheral vision is considered to include near peripheral FOV 340 as well. Of course, other delineations between central and peripheral vision may be applied.

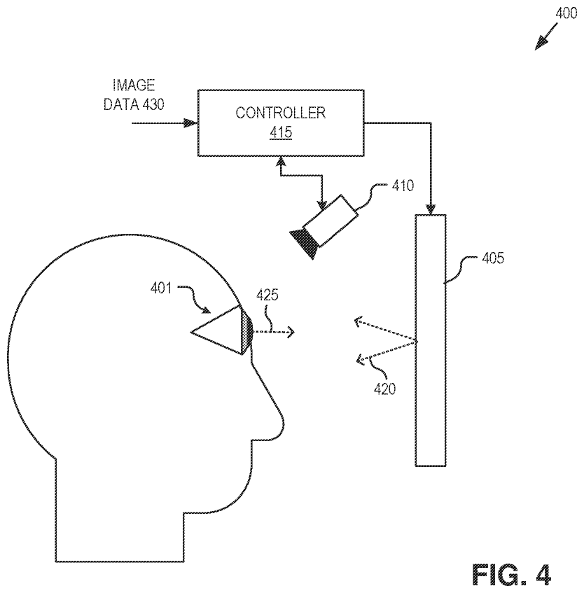

FIG. 4 is a block diagram illustrating a system 400 for providing emmetropization therapy using simulated LCA, in accordance with an embodiment of the disclosure. The illustrated embodiment of system 400 includes a display 405, a camera 410, and a controller 415.

Display 405 may be implemented with a variety of different color display technologies. Display 405 may be a liquid crystal display (LCD), an organic light emitting diode (OLED) display, or otherwise. In particular, personal computing devices such as smart phones, tablet computers, laptops, desktop computers etc. are well suited to implement the techniques described herein. It is noteworthy that display 405 does not require expensive lenses for optically defocusing color image 420 emitted from display 405. Rather, the myopic defocus is simulated in software and/or dedicated hardware logic.

In the illustrated embodiment, system 400 includes a camera 410 for tracking a gazing direction 425 of eye 401. Camera 410 may be an external camera that mounts to display 405 or an integrated camera. Although FIG. 4 illustrates a single camera 410, in other embodiment, one or more offset cameras (e.g., stereovision) may be used to track the user's gazing direction 425. Camera 410 is an optional feature as gaze tracking need not be included in all implementations.

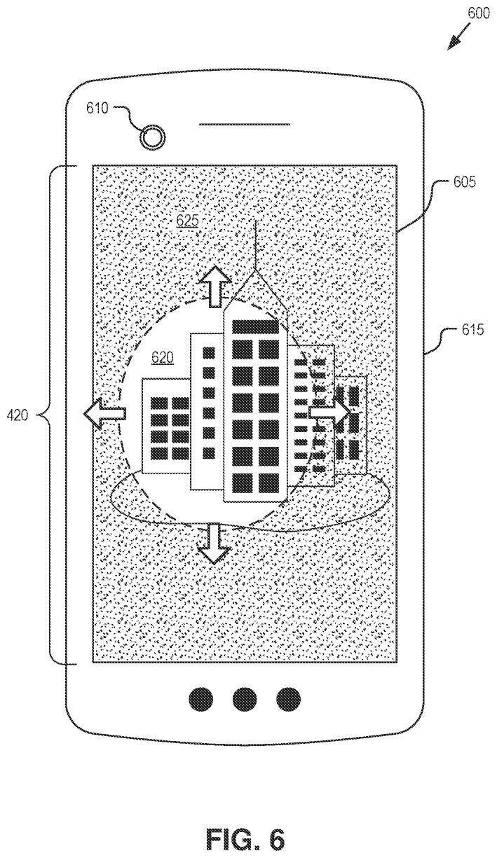

Controller 415 is coupled to display 405 and camera 410 to choreograph their operation. Controller 415 may be implemented as a general-purpose processor that executes software instructions stored in a memory, as hardware logic (e.g., application specific integrated circuit, field programmable gate array, etc.), or a combination of both. Controller 415 may be a separate module that couples to display 405 and camera 410, or integrated circuitry/logic that is disposed within a single computing device. For example, FIG. 6 illustrates an example system 600 including a display 605 for outputting color image 420, a camera 610, and an internal microcontroller disposed within housing 615 having a smart phone or tablet form factor. System 600 is one possible implementation of system 400.

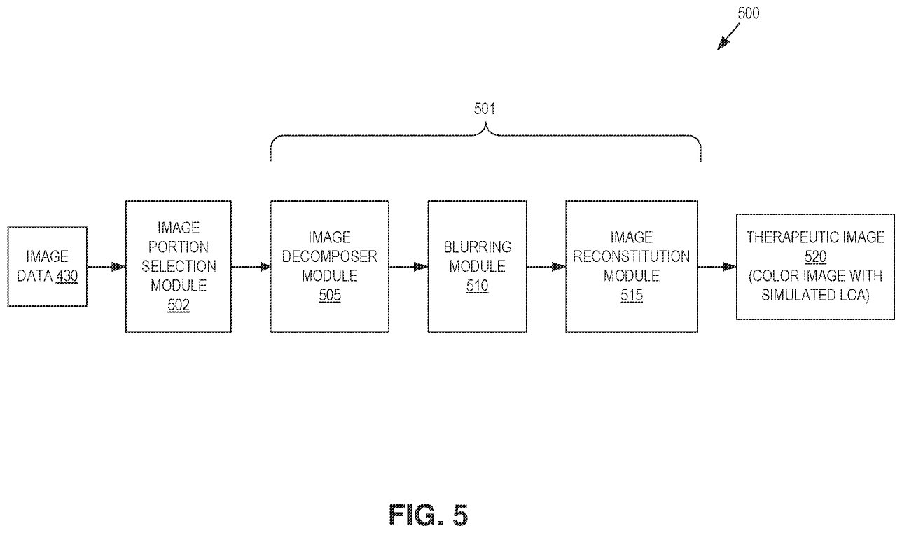

During operation, controller 415 receives image data 430 corresponding to a color image, selectively blurs at least one color channel of image data 430 in at least a portion of the color image to provide simulated LCA in that portion of the color image, and then displays color image 420 with the simulated LCA to provide an emmetropization therapy. Image data 430 may represent a variety of data types, such as color pictures or a video data stream for a video. FIG. 5 is a block diagram illustrating a control architecture 500 executed by controller 415 for introducing the simulated LCA (chromatic blurring) into a selective portion (e.g., fixed peripheral portion, full image portion, dynamic peripheral portion that moves location based upon real-time gaze tracking) of color image 420, in accordance with an embodiment of the disclosure. Color image 420 with the simulated LCA is also referred to as a therapeutic image. Accordingly, controller 415 operates as a display driver that adjusts image data 430 to simulate chromatic cues presented to the retina for treating myopia.

The illustrated embodiment of control architecture 500 includes an image portion selection module 502, an image decomposer module 505, a blurring module 510, and an image reconstitution module 515. The function of each of these modules is described below. However, it should be appreciated that image decomposer module 505, blurring module 510, and an image reconstitution module 515 form a rendering pipeline 501 that may be implemented using a variation of the ChromaBlur software described in “ChromaBlur: Rendering Chromatic Eye Aberration Improves Accommodation and Realism” by Cholewiak et al. Rendering pipeline 501 may be implemented at the software level or at a lower level of hardware integration (field programmable gate array, application specific integrated circuit, etc.). For example, rendering pipeline 501 may be integrated into the display hardware itself and applied across all media types displayed on the screen. In this case, the blurring scheme described may manipulate the image at a hardware level encoding such as PAL, NTSC, SECAM, Display Serial Interface, Digital Visual Interface, or otherwise.

Image portion selection module 502 operates to select the portion of color image 420 to which chromatic blurring is to be applied. This portion may represent the entire color image 420. Alternatively, this portion may be a peripheral portion 625 that surrounds a central or fixation region 620 (see FIG. 6). The peripheral portion 625 may be stationary and simply surrounds a central region of color image 420, or dynamic and surrounds a fixation region that moves about color image 420 based upon the user's gazing direction.

Image decomposer module 505 decomposes image data 430 into multiple color channels. In one embodiment, image decomposer module 505 decomposes image data 430 into three color channels (e.g., red channel, green channel, and a blue channel). Of course, other color models may be implemented. Blurring module 510 selectively blurs the image data in one or more color channels in the select image portion. The blurring is a chromatic blurring that only blurs the selected color component(s) of image pixels falling within the region of color image 420 designated by image portion selection module 502. The chromatic blurring may be applied to a single color channel (e.g., just blue channel) or multiple color channels (e.g., blue and green channels). In one embodiment, the blurring is applied as a gradient blur where the shorter wavelength color channels receive greater blurring than the longer wavelength color channels. For example, a blue channel may receive the greatest chromatic blur, the green channel may receive less or no chromatic blur while the red channel does not receive any chromatic blur. In another embodiment, the blurring is applied only to blue and red, leaving green in sharp focus. The chromatic blur may be implemented by spatially spreading image pixels of color image 420 in only the select color channels. For example, a white image pixel (or any color image pixel) may be decomposed into component colors and manipulated to have a sharp red center with a blurred fringe (i.e., spatial spreading) of blue and green components. The same technique holds true for black and white images (e.g., a page of text). Fonts may even be calculated with a predetermined amount of LCA, which may be applied at least across a portion of a field of text within image 420.

After the selected image pixels have been chromatically blurred, the image data of the color channels are recombined to reconstitute color image 420 with the simulated LCA in the selected image portions. Image reconstitution module 515 implements this recombining process to generate the therapeutic image 520 (i.e., color image 420 with simulated LCA).

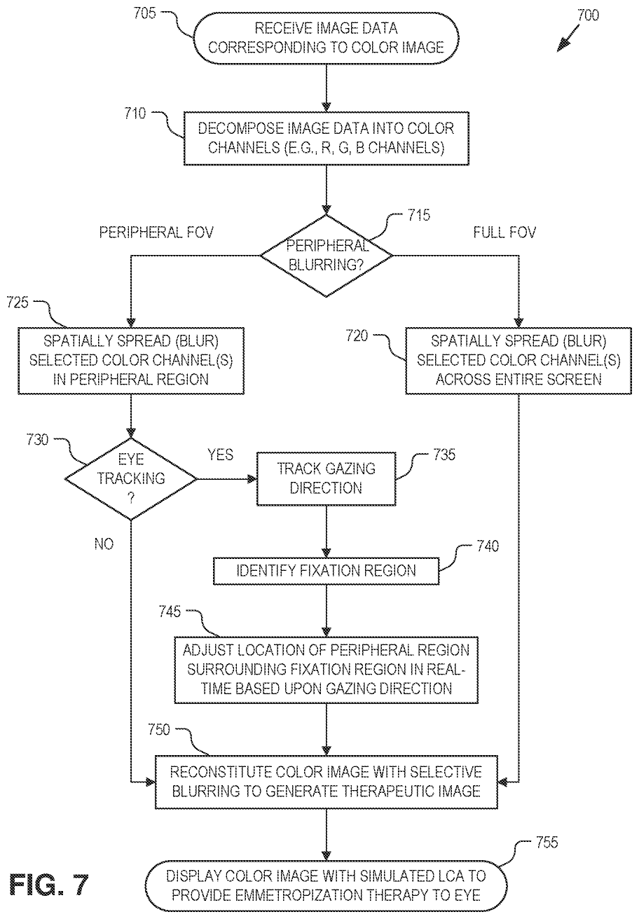

FIG. 7 is a flow chart illustrating a process 700 of providing emmetropization therapy using simulated LCA, in accordance with an embodiment of the disclosure. Process 700 is described with reference to the illustrated embodiments of FIGS. 4-6. The order in which some or all of the process blocks appear in process 700 should not be deemed limiting. Rather, one of ordinary skill in the art having the benefit of the present disclosure will understand that some of the process blocks may be executed in a variety of orders not illustrated, or even in parallel.

In a process block 705, controller 415 receives image data 430 corresponding to color image 420. Image data 430 may represent a variety of different types of image data such as digital images (e.g., jpeg, png, tiff, gif, etc) or a video data stream (e.g., mpeg, MP4, H.264, H.265, AAC, AVI, etc.). In a process block 710, rendering pipeline 501 decomposes image data 430 into multiple color channels corresponding to different color wavelengths (e.g., red, green, and blue channels).

If an entire portion of color image 420 is to be chromatically blurred (decision block 715), then process 700 continues to a process block 720 where blurring module 510 chromatically blurs (e.g., spatial color blurring) image data corresponding to one or more of the color channels across the entire color image 420. Correspondingly, if only a peripheral portion of color image 420 is to be chromatically blurred (decision block 715), then process 700 continues to a process block 725. In process block 725, a peripheral portion 625 of color image 420 is chromatically blurred in one or more color channels while a central portion 620 is left unblurred.

The use of peripheral visual stimulation for emmetropization therapy may be applied to a stationary peripheral portion of color image 420 disposed around a stationary central portion of color image 420. In this case eye tracking is not used (decision block 730) and process 700 continues to process block 750. However, if eye tracking is used (decision block 730), then peripheral region 625 is a dynamic peripheral region that surrounds a fixation region 620 representing the user's central vision. As the user's scans their gaze about color image 420, fixation region 620 changes. As such, controller 415 uses camera 410 to track the eye's gazing direction 425 (process block 735) and identify the location of fixation region 620 within color image 420 in real-time based upon the determined gazing direction 425 (process block 740). As gazing direction 425 changes, the location of fixation region 620 and dynamic peripheral region 625 is revised/adjusted to account for the changing location of fixation region 620 (process block 745). These revisions may be made to ensure the user's central vision with higher acuity receives a sharp image while peripheral region 625 having one or more blurred color channels (i.e., simulated LCA) is incident upon the user's peripheral vision. In other embodiments, the user's full field vision may be blurred without any central zone or eye tracking.

In a process block 750, image reconstitution module 515 reconstitutes the image data of the various color channels to generate the color image 420 with simulated LCA in the selected portions or regions of color image 420. As mentioned above, this color image 420 with simulated LCA may also referred to as therapeutic image 520. Finally, in a process block 755 therapeutic image 520 is output from display 405 (or 605) to provide emmetropization therapy to the eye.

The principles discussed above to drive emmetropization of an eye may be performed in software using simulated LCA as discussed above, or performed optically using optical lensing to induce myopic defocus across a user's full FOV (see FIG. 2B). In this optical embodiment, an eye mountable device (e.g., contact lens) or head wearable device (e.g., eyeglasses) may be used to intentionally induce actual LCA. For example, a contact lens or eyeglasses may include lenses, such as an achromatic doublet or diffractive surfaces, that minimizes LCA for longer wavelengths (e.g, red) but intentionally induces LCA in shorter wavelength (e.g., blue) to create the impression of small amounts of myopic defocus. Greater amounts of defocus may include blurring blue and red. It is noteworthy that this is the opposite of conventional lens manufacturing goals, which typically seek to reduce or eliminate LCA in their optical systems. The degree of LCA (e.g., amount of spatial spreading) may be enhanced along a gradient (e.g., in a non-linear or linear fashion) such that the lenses include zero LCA in long wavelengths while progressively higher LCA is induced in shorter wavelengths. In other words, a gradual amount of LCA may be optically induced from no LCA in the red spectrum to substantially more LCA in the blue spectrum. In some embodiments, it may be desirable to selectively blur blue and red, while substantially not blurring green.

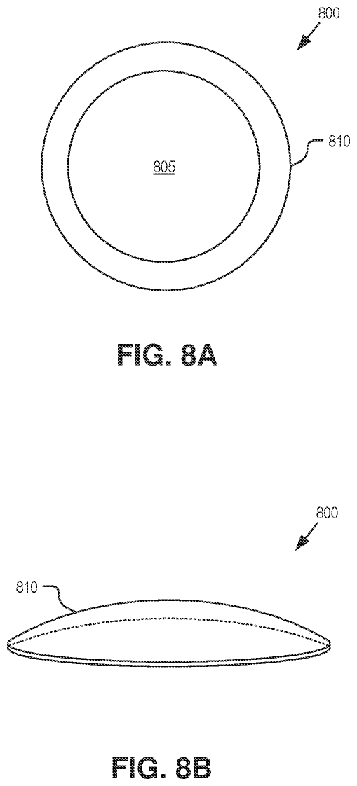

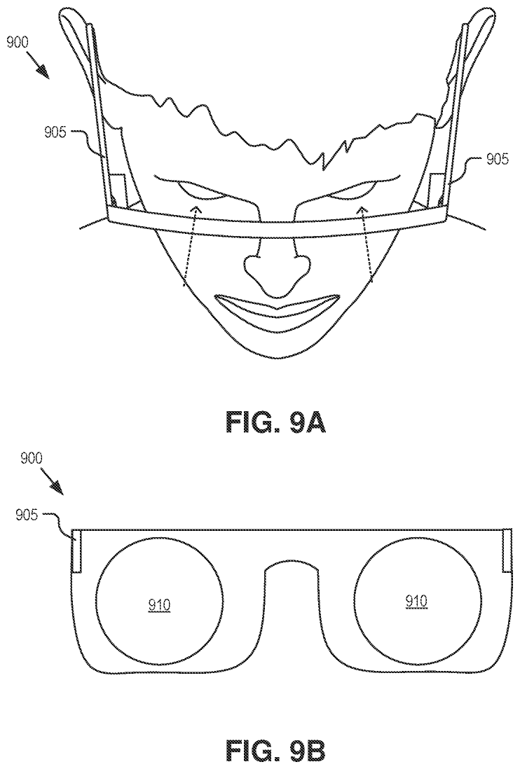

FIGS. 8A & 8B illustrate a demonstrative implementation of an eye mountable device (EMD) 800 for therapeutically treating myopia, in accordance with an embodiment of the disclosure. The illustrated embodiment of EMD 800 includes a lens 805 disposed within a biocompatible enclosure 810. Lens 805 is positioned in the user's central vision and has a field curvature that induces LCA in the user's vision to provide emmetropization therapy similar to the simulated blur discussed above. The lens 805 may be implemented as a single zone lens that applies LCA correction across the user's entire FOV, or a multi-zone lens that induces LCA in the user's peripheral vision while not contributing LCA in the user's central vision.

FIGS. 9A & 9B illustrate a demonstrative ophthalmic eyewear 900 including frames 905 for positioning lenses 910 in front of the wearer's eyes. Lenses 910 include field curvatures to provide emmetropization therapy using LCA, in accordance with an embodiment of the disclosure. Lenses 910 operate in a similar manner as lenses 805 described above.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of encouraging emmetropization of an eye, the method comprising:
receiving image data corresponding to a color image;
blurring a first color channel of the image data greater than a second color channel of the image data in at least a portion of the color image to provide a simulated longitudinal chromatic aberration (LCA) in the portion of the color image; and
displaying the color image with the simulated LCA to provide an emmetropization therapy to the eye.

2. The method of claim 1, where the first color channel is associated with a shorter wavelength than the second color channel.

3. The method of claim 2, wherein the image data further includes a third color channel associated with an intermediate wavelength between the first and second color channels.

4. The method of claim 3, wherein the first color channel is blurred in the portion of the color image while the second color channel is not blurred.

5. The method of claim 3, wherein the first and third color channels are blurred in the portion of the color image.

6. The method of claim 5, wherein greater blurring is applied to the first color channel than is applied to the third color channel.

7. The method of claim 3, wherein the first color channel comprises a blue channel, the third color channel comprises a green channel, and the second color channel comprises a red channel of the image data.

8. The method of claim 1, wherein blurring the first color channel of the image data greater than the second color channel of the image data includes blurring blue and red color channels while substantially not blurring a green color channel.

9. The method of claim 1, wherein blurring the first color channel comprises spatially spreading image pixels of the first color channel in the portion of the color image.

10. The method of claim 1, wherein the simulated LCA comprises a peripheral simulated LCA and the portion of the color image comprises a peripheral region of the color image surrounding a central region of the color image that is not blurred to include the simulated LCA.

11. The method of claim 1, wherein the portion of the color image in which simulated LCA is generated comprises a dynamic peripheral region of the color image surrounding a fixation region, the method further, comprising:
tracking a gazing direction of the eye with a camera as the eye looks around the color image;
identifying the fixation region within the color image upon which the eye is centrally fixated based upon the gazing direction; and
revising a location of the dynamic peripheral region as the fixation region changes such that the dynamic peripheral region remains in a peripheral vision of the eye while the eye looks around the color image.

12. The method of claim 1, wherein the image data is a portion of a video data stream and the color image comprises a portion of a video.

13. The method of claim 1, wherein the first color channel comprises a red color channel.

14. At least one machine-accessible storage medium that provides instructions that, when executed by a machine, will cause the machine to perform operations to provide emmetropization therapy to an eye, the operations comprising:
receiving image data corresponding to a color image;
decomposing the image data into color channels including at least first and second color channels where the first color channel is different than the second color channel;
blurring the first color channel greater than the second color channel in at least a portion of the color image;
reconstituting the image data with the first channel blurred greater than the second channel in the portion of the color image to provide a simulated longitudinal chromatic aberration (LCA) in the portion of the color image; and
displaying the color image to the eye with the simulated LCA to provide the emmetropization therapy to the eye.

15. The at least one machine-accessible storage medium of claim 14, where the first color channel is associated with a shorter wavelength than the second color channel.

16. The at least one machine-accessible storage medium of claim 15, wherein the color channels further include a third color channel associated with an intermediate wavelength between the first and second color channels.

17. The at least one machine-accessible storage medium of claim 16, wherein the first color channel is blurred in the portion of the color image while at least one of the second color channel or the third color channel is not blurred.

18. The at least one machine-accessible storage medium of claim 16, wherein the first and third color channels are blurred in the portion of the color image.

19. The at least one machine-accessible storage medium of claim 18, wherein greater blurring is applied to the first color channel than is applied to the third color channel.

20. The at least one machine-accessible storage medium of claim 16, wherein the first color channel comprises a blue channel, the third color channel comprises a green channel, and the second color channel comprises a red channel of the image data.

21. The at least one machine-accessible storage medium of claim 14, wherein blurring the first color channel comprises spatially spreading image pixels of the first color channel in the portion of the color image.

22. The at least one machine-accessible storage medium of claim 14, wherein the simulated LCA comprises a peripheral simulated LCA and the portion of the color image comprises a peripheral region of the color image surrounding a central region of the color image that is not blurred to include the simulated LCA.

23. The at least one machine-accessible storage medium of claim 14, wherein the portion of the color image in which simulated LCA is generated comprises a dynamic peripheral region of the color image surrounding a fixation region, and where the at least one machine-accessible storage medium further provides instructions that, when executed by the machine, will cause the machine to perform further operations, comprising:
tracking a gazing direction of the eye with a camera as the eye looks around the color image;
identifying the fixation region within the color image upon which the eye is centrally fixated based upon the gazing direction; and
revising a location of the dynamic peripheral region as the fixation region changes such that dynamic peripheral region remains in a peripheral vision of the eye while the eye looks around the color image.
